(19) United States
(12) Patent Application Publication
(10) Pub. No.: US 2001/0001328 A1
(43) Pub. Date: May 17, 2001

(54) Link apparatus and virtual machine

(76) Inventors: Chikara Yoshida, Kyoto-shi (JP); Nobuki Tominaga, Kyoto-shi (JP); Shusuke Haruna, Itami-shi (JP)

Correspondence Address: Joseph W. Price, PRICE, GESS & UBELL, Ste. 250, 2100 S.E. Main St., Irvine, CA, 92614, US

(21) Appl. No.: 09/748,607

(22) Filed: Dec. 26, 2000

(30) Foreign Application Priority Data
Oct. 16, 1998 (JP) 10-294934

(51) Int. Cl. G06F 9/45

(52) U.S. Cl. 717/5; 709/1

(57) ABSTRACT

A method number deciding unit 143 sets method numbers for methods in each class into the base method number table so that each method number within one class is different. A method table generating unit 144 generates a method table for each method, the method table including a pointer that is an offset form a first position of an executable program to an area where information relating to the method is stored, and additionally writes the generated method table at the first position of the class file. A method call instruction converting unit 145 replaces, when an instruction “invokevirtual” exists in a class file, a constant pool entry number written in an operand of the instruction with a method number, and deletes a constant pool entry indicated by the constant pool entry number.

On receiving the instruction “invokevirtual”, the method call unit 174 calculates an address by summing a first address of an executable program and a content of an operand of the instruction, and calls a method stored at the position indicated by the calculated address.

### BACKGROUND OF THE INVENTION

1. 1. Field of the Invention

2. The present invention relates to a technique for compiling a program written in an object-oriented language, performing linking on the program, and executing the program.

3. 2. Description of the Prior Art

4. In recent years, the general-purpose programming language Java that adopts a concept of an object-orientation has widely been used. With the use of Java, coding that is similar to C++ is realized. (Java is a registered trademark of Sun Microsystems, Inc. in the U.S.)

5. (First Prior Art)

6. A source program written in Java is executed as follows.

7. A Java compiler compiles a source program that is written in Java and that includes a plurality of classes, to generate object modules called class files for each of the classes. Each class file includes an area called a constant pool where an identifier for identifying the class and identifiers for identifying methods written in the source program are stored in the form of character strings.

8. A Java virtual machine is capable of linking a plurality of class files that include the same character string by searching constant pools in the class files for the same character string. For example, by detecting class files whose constant pools store a class name expressed with the same character string, classes with the same identifier in the detected class files are linked. The Java virtual machine then executes the linked class files.

9. As described above, a constant pool in a class file stores an identifier for identifying the class and identifiers for identifying methods in the form of character strings. Using these character strings, a plurality of class files can be linked. However, the problem is that the size of a class file is likely to increase if character strings are stored as they are in the constant pool in the class file. Moreover, the Java virtual machine executes class files only after having first linked the class files, which lowers the processing speed. These are serious problems, especially for a computer device with limited storage, such as a portable information terminal, a household electric appliance, or a portable telephone.

10. (Second Prior Art)

11. In view of the above problems, a system that enables Java programs to be processed smoothly by computers with limited storage has been devised. A unit to perform linking is provided separate to the Java virtual machine. This system is composed of a static link apparatus that performs static linking and a virtual machine that executes instructions.

12. In the above system, the static link apparatus links a plurality of class files and generates one object file. The generated object file includes addresses that indicate classes and methods stored in an area outside the object file. Using the addresses, classes and methods can be referenced. The virtual machine reads and executes the object file generated by the static link apparatus.

13. As explained above, the object file in the second prior art does not store character strings written in the source program as described in the first prior art. Therefore, the size of the object file can be reduced. Furthermore, a plurality of class files are linked when the program is compiled, that is, before the program is executed. This prevents the processing speed from being affected.

14. However, a problem occurs when a source program is coded in such a manner that an object of a class is declared by a variable and a method in an object bound with the variable is called. In that case, the content of the variable is not decided until an object of the class is actually assigned to the variable. Therefore, the static linking described above cannot be performed.

### SUMMARY OF THE INVENTION

15. In view of the above problems, the present invention aims to provide, when a source program is coded in such a manner that an object of a class is declared by a variable and a method in an object bound with the variable is called, a link apparatus that is capable of static linking of class files while preventing the size of the class files from increasing, a virtual machine that executes generated class files, and an information processing system composed of a compiling apparatus, the link apparatus, and the virtual machine, and a storage medium that stores a link method and a link program.

16. Here, a link apparatus that links a plurality of class files generated when a source program written in an object-oriented language is compiled, each class file including a constant pool, and that outputs each class file as an executable program, the link apparatus may comprise: class file storing means for storing at least one class file that includes a method and an identification character string to identify the method, the identification character string being stored in the constant pool in the class file; address adding means for (1) reading each class file from the class file storage means, (2) detecting, in different class files that are read, a plurality of methods that are identified by a same identification character string, and (3) writing an address of each detected method into a fixed position in each class file, the address showing a storage position of the method in the class file; and character string deleting means for deleting an identification character string that identifies the detected method from a constant pool in each class file into which an address is written, and wherein the link apparatus outputs, after the address adding means writes an address into a class file and the character string deleting means deletes an identification character string from the class file, the class file as an executable file. Here, class files stored by the class file storing means each include an entry area in a constant pool, the entry area being identified by an entry number and storing the identification character string, and one of the class files stored by the class file storing means may further include at least one method, the method including: (a) an instruction to bind a variable with an instance of one class; and (b) a call instruction that includes an entry number and calls code of a method identified by an identification character string stored in an entry area indicated by the entry number and included in the instance bound with the variable, and wherein the link apparatus further comprises, instruction converting means for replacing, when a method in a class file includes the call instruction, the entry number in the call instruction in the class file with a method number generated for a method identified using the entry number. Here, a virtual machine that operates according to an executable program outputted by the link apparatus may comprise: instruction reading means for reading a call instruction included in the executable program; method number reading means for reading an address corresponding to a method number included in the read call instruction from a method table; and execution means for branching to the read address and executing code of a method stored at a position indicated by the read address.

17. According to this construction, the address adding means in the link apparatus writes, as to a plurality of methods that are identified by a same identification character string and are included in different class files, an address that indicates a storage position where code of a method is stored in a class file, into a fixed position in the class file. The virtual machine executes a method indicated by an address having been written at the fixed position. Therefore, even when the source program is coded in such a manner that an object of a class is declared by a variable and a method in an object bound with the variable is called, static linking of the above methods can be performed before a program is executed, and the linked methods can be executed.

18. Here, as the identification character string that identifies the method is deleted from the constant pool, increases of the size of the class file can be prevented.

### BRIEF DESCRIPTION OF THE DRAWINGS

19. These and other objects, advantages and features of the invention will become apparent from the following description thereoftaken in conjunction with the accompanying drawings that illustrate a specific embodiment of the invention. In the drawings:

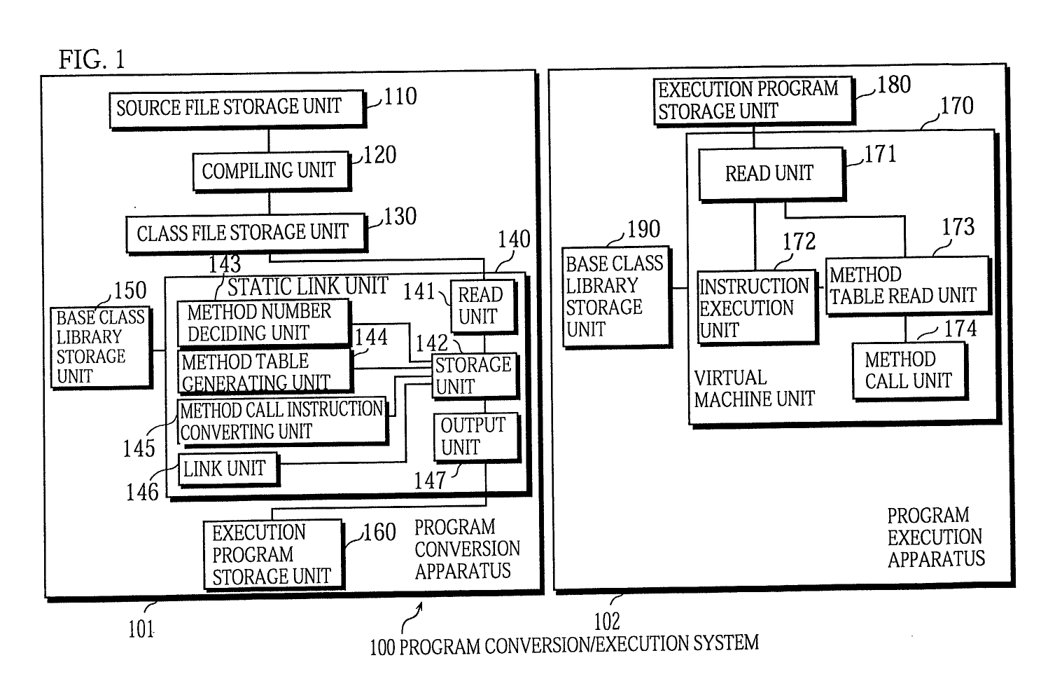

20. FIG. 1 is a block diagram showing the construction of a program conversion/execution system that is a preferred embodiment of the present invention.

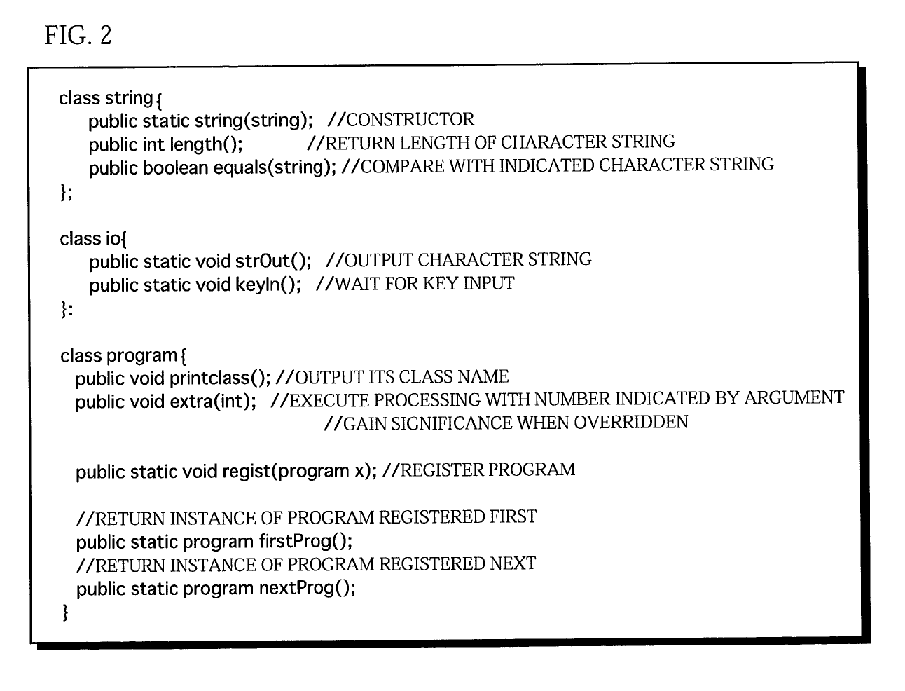

21. FIG. 2 shows base classes and methods stored in the base class library storage unit 150.

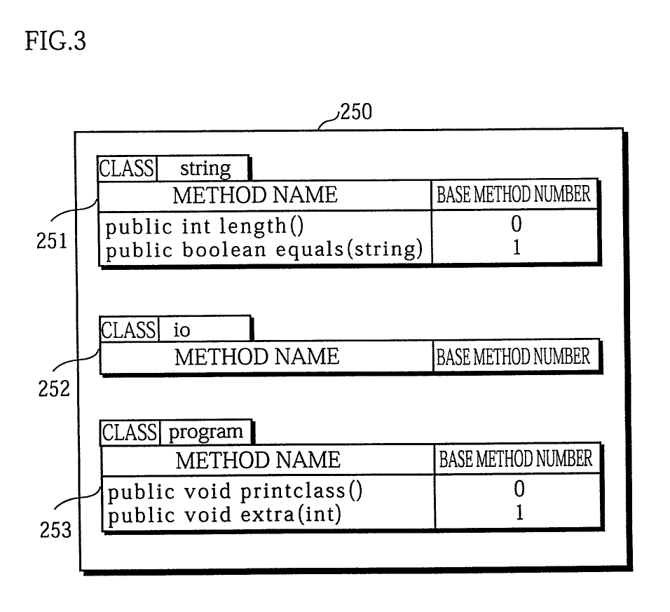

22. FIG. 3 shows data structure of the base method number table.

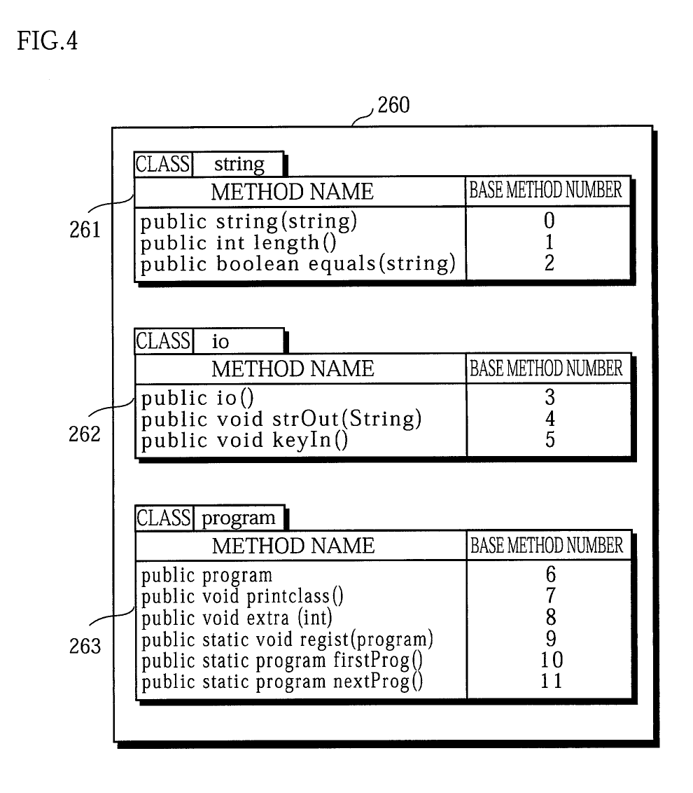

23. FIG. 4 shows data structure of the base method serial number table.

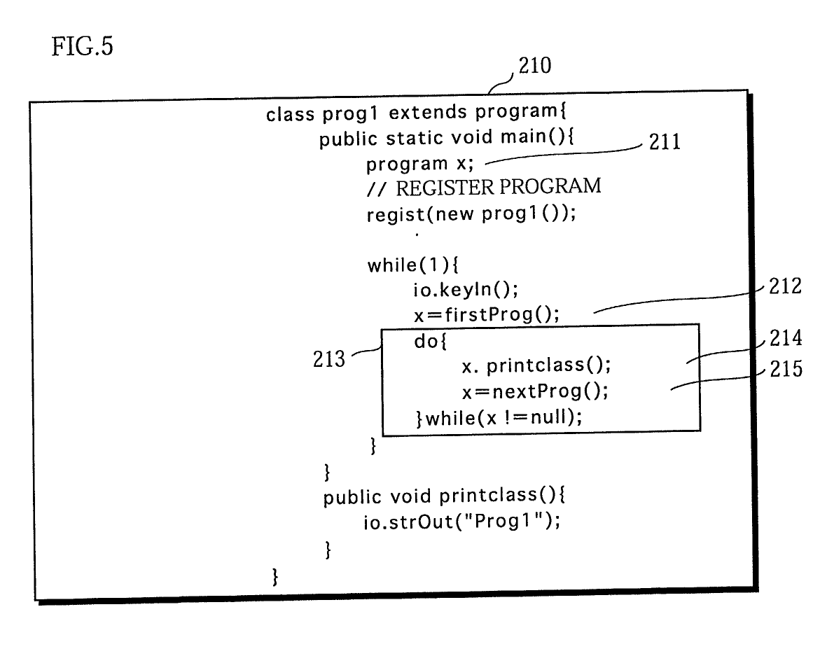

24. FIG. 5 shows a file 210 stored in the source file storage unit 110.

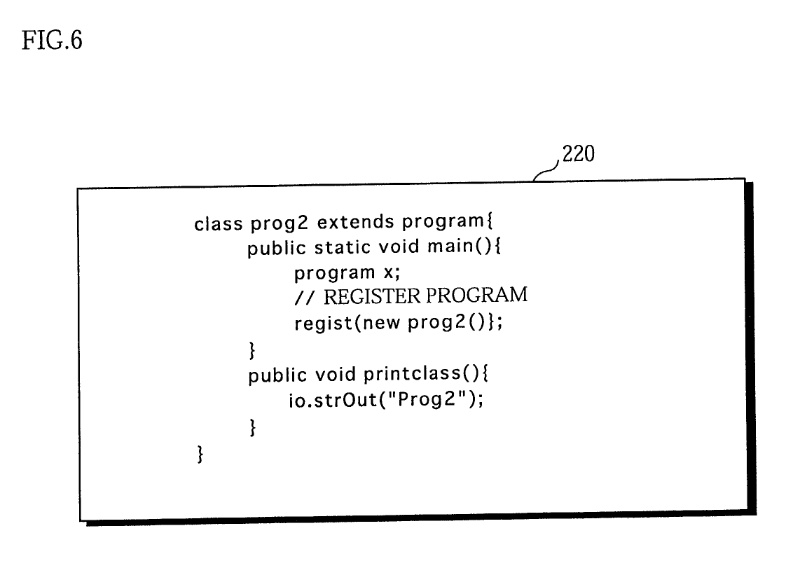

25. FIG. 6 shows a file 220 stored in the source file storage unit 110.

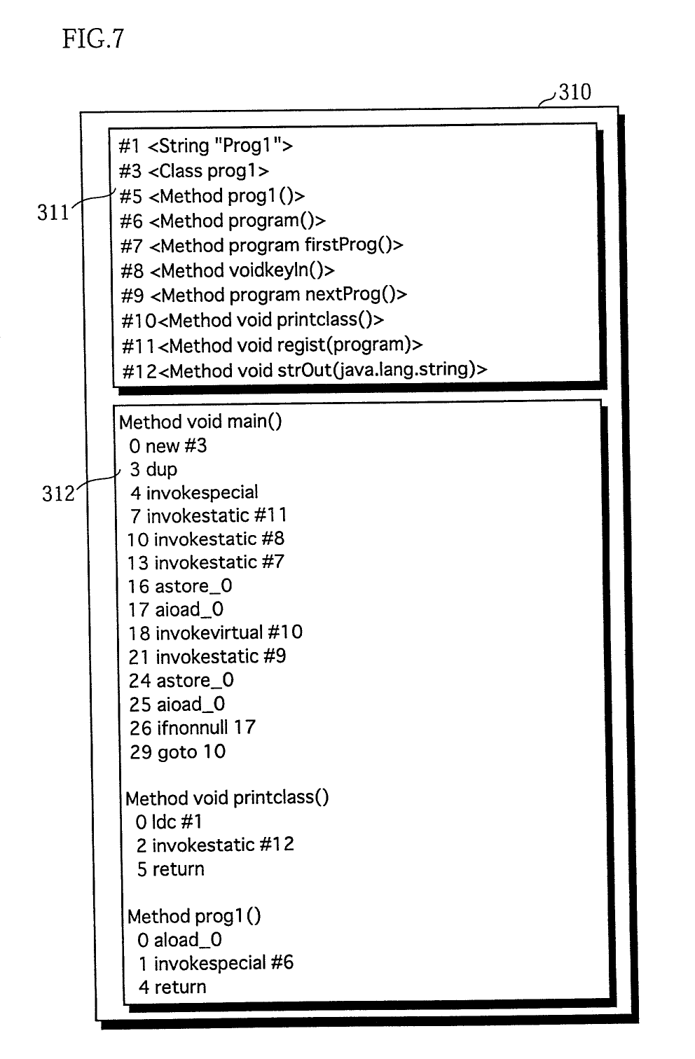

26. FIG. 7 shows a class file 310 stored in the class file storage unit 130.

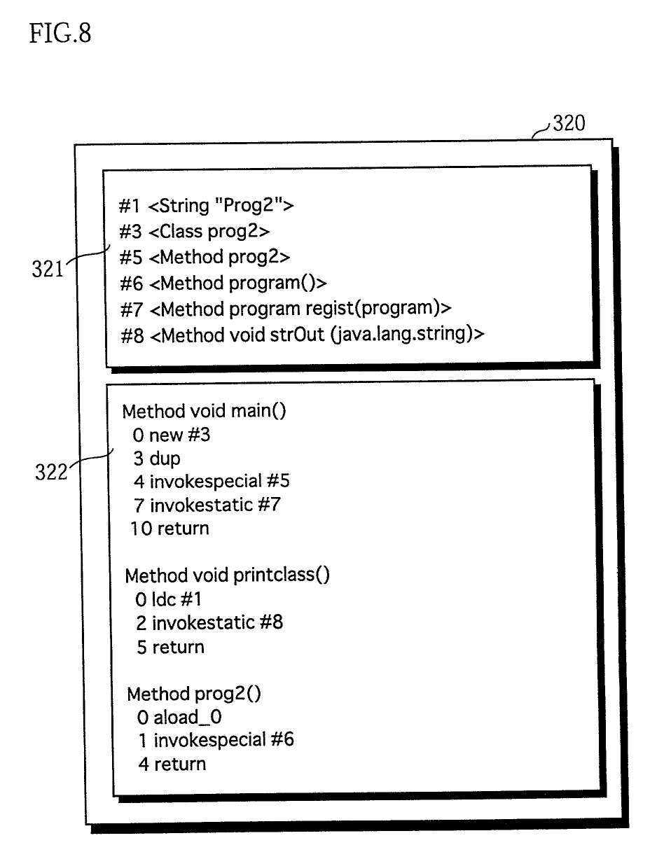

27. FIG. 8 shows a class file 320 stored in the class file storage unit 130.

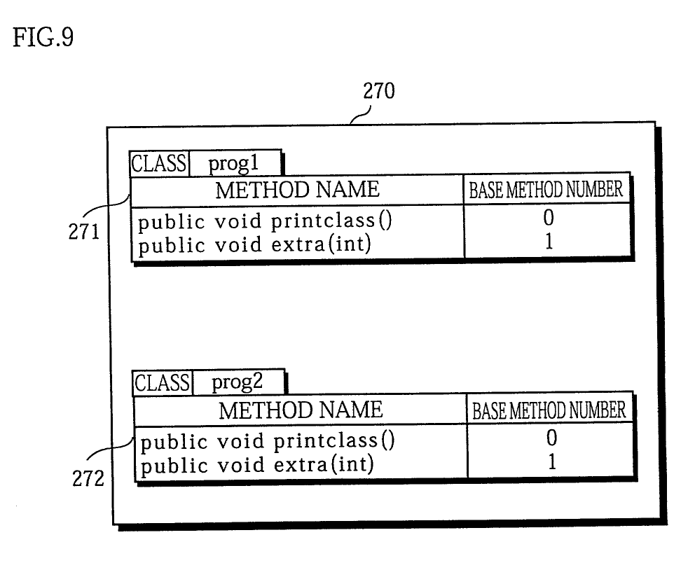

28. FIG. 9 shows examples of pairs consisting of method names and method numbers generated by the method number deciding unit 143.

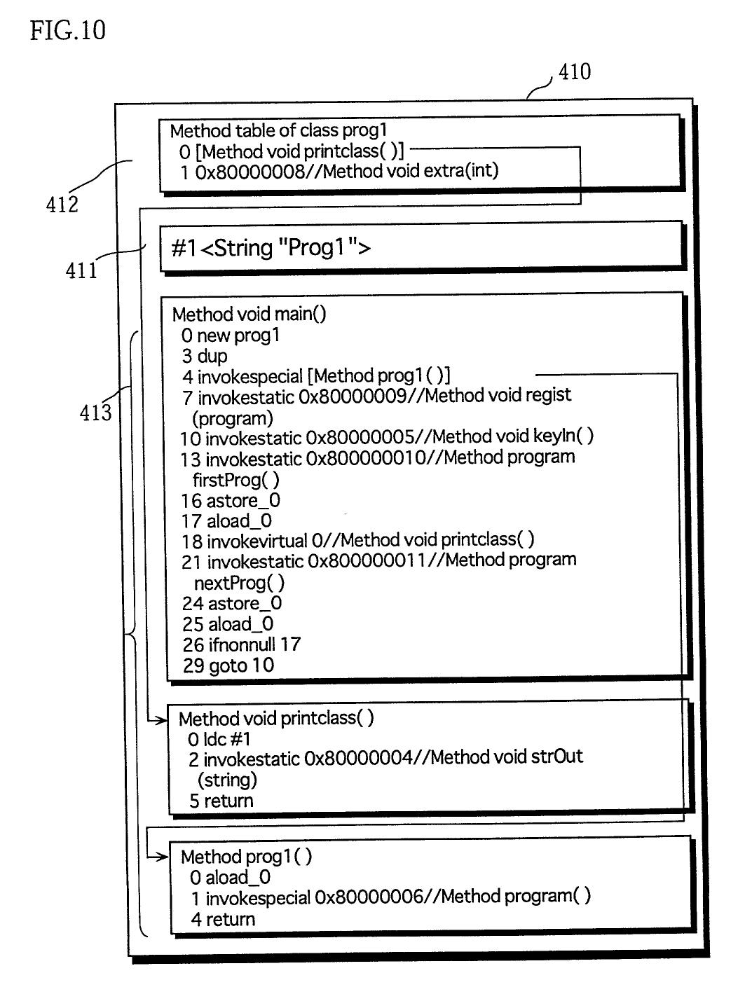

29. FIG. 10 shows an executable file 410 stored in the execution program storage unit 160.

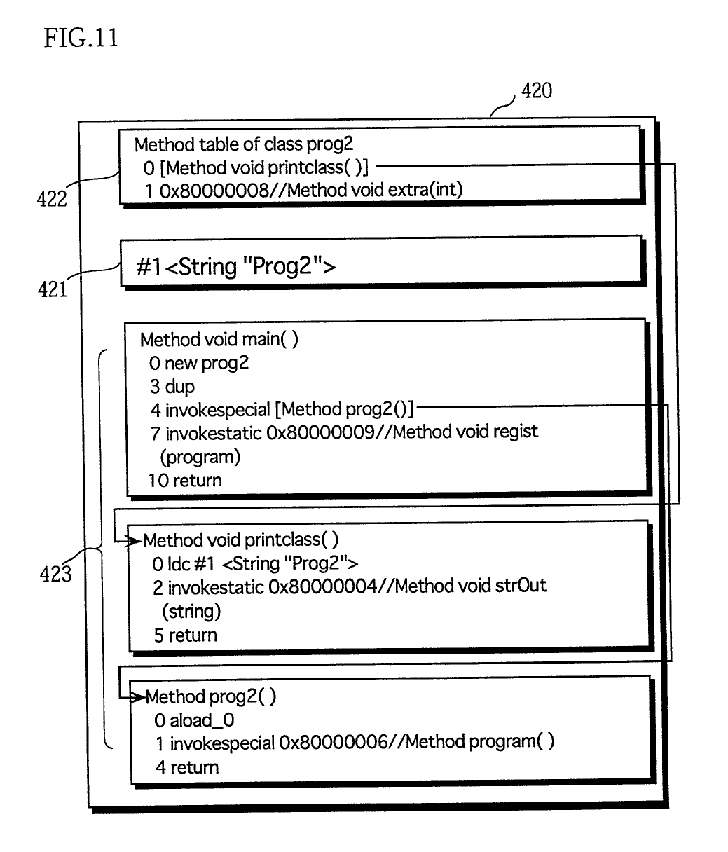

30. FIG. 11 shows an executable file 420 stored in the execution program storage unit 160.

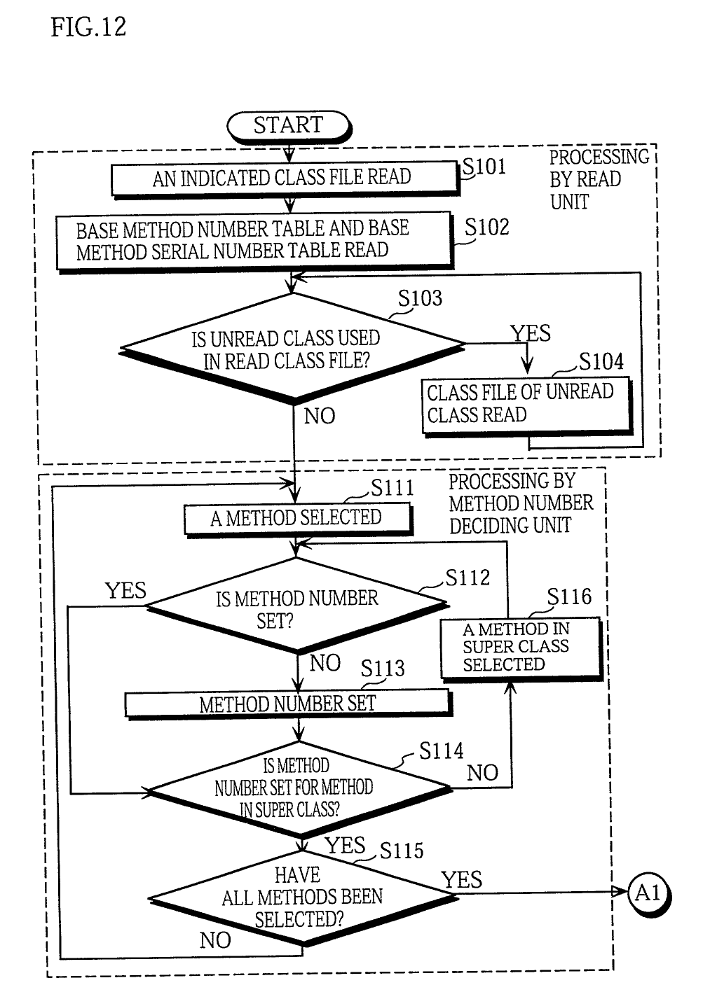

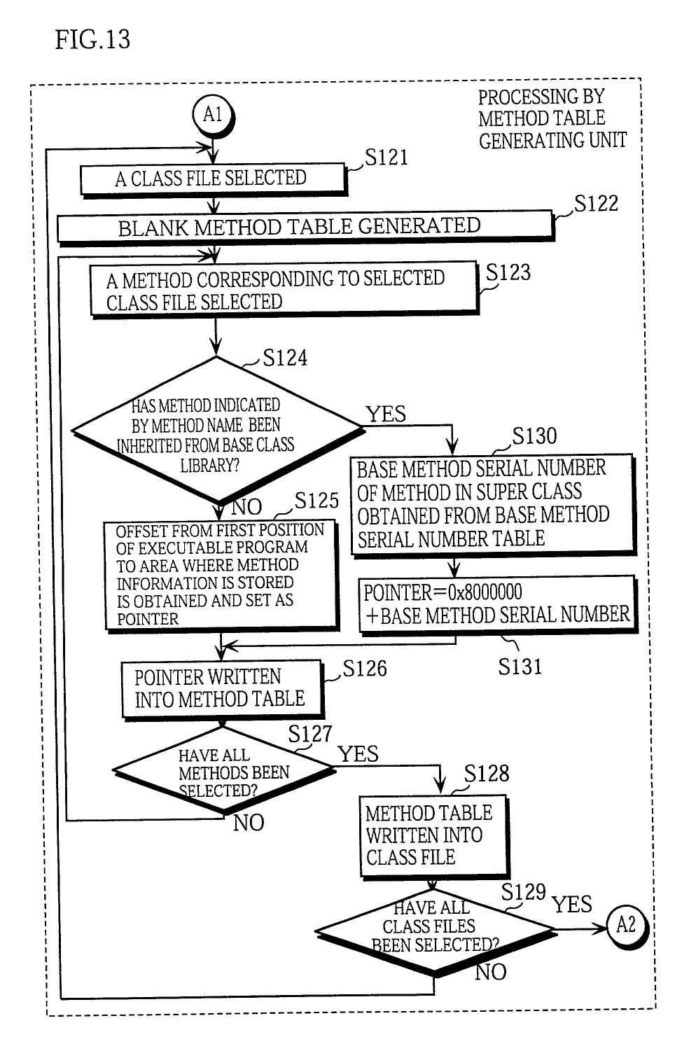

31. FIG. 12 is a flowchart showing the operation of the static link unit 140 in the program conversion apparatus 101. This flowchart continues to FIG. 13.

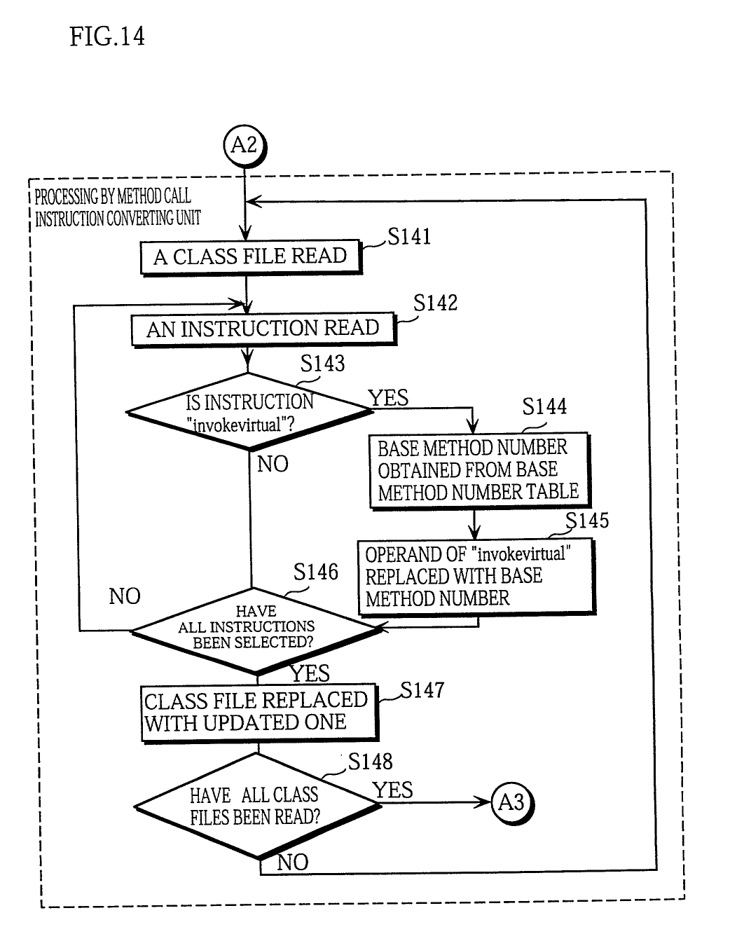

32. FIG. 13 is a flowchart showing the operation of the static link unit 140 in the program conversion apparatus 101. This flowchart continues to FIG. 14.

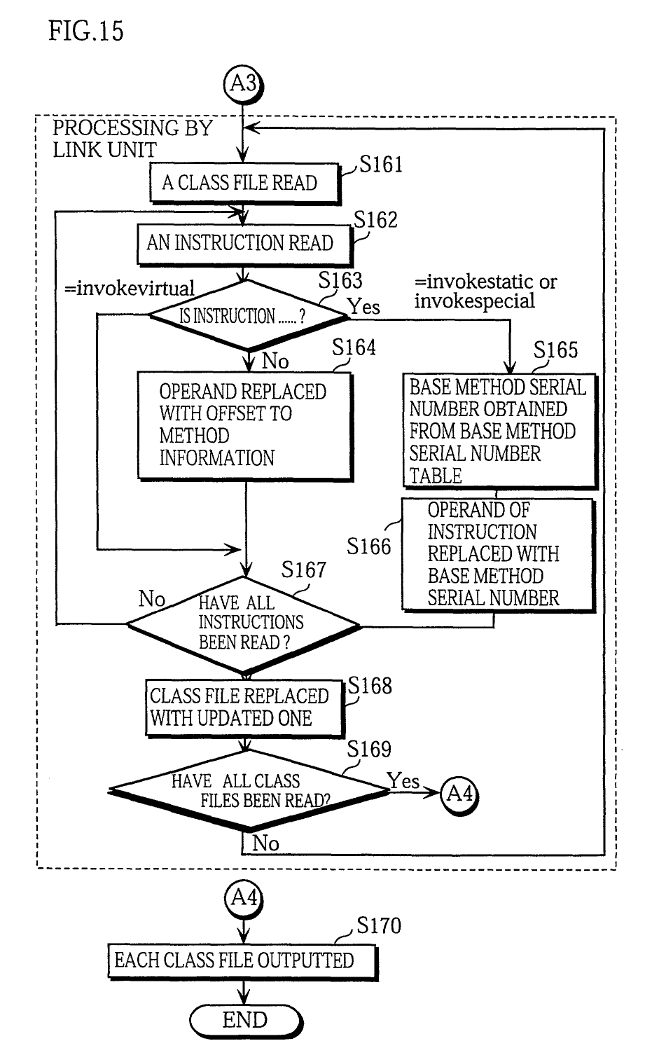

33. FIG. 14 is a flowchart showing the operation of the static link unit 140 in the program conversion apparatus 101. This flowchart continues to FIG. 15.

34. FIG. 15 is a flowchart showing the operation of the static link unit 140 in the program conversion apparatus 101. This flowchart starts from FIG. 14.

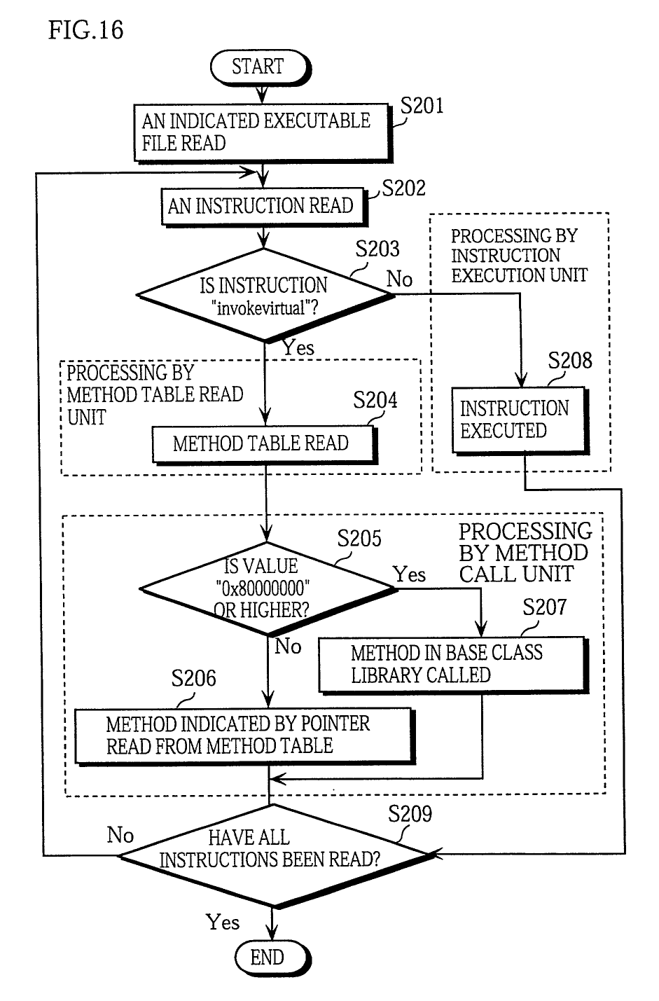

35. FIG. 16 is a flowchart showing the operation of the program execution apparatus 102.

### DESCRIPTION OF THE PREFERRED EMBODIMENT

36. The following is an explanation of a program conversion/execution system 100 according to an embodiment of the present invention, with reference to the drawings.

37. 1. Construction of the Program Conversion/Execution System 100

38. The program conversion/execution system 100 is composed of a program conversion apparatus 101 and a program execution apparatus 102 as shown in FIG. 1.

39. The program conversion apparatus 101 includes a source file storage unit 110, a compiling unit 120, a class file storage unit 130, a static link unit 140, a base class library storage unit 150, and an execution program storage unit 160. More specifically, the program conversion apparatus 101 is a computer system that may be constructed of a microprocessor, a random access memory (RAM), a read only memory (ROM), a hard disk unit, a display unit, a keyboard, and a mouse. The hard disk unit stores a computer program. The microprocessor operates according to the computer program, so that the compiling unit 120 and the static link unit 140 perform their functions.

40. The program execution apparatus 102 is composed of a virtual machine unit 170, an execution program storage unit 180, and a base class library storage unit 190. More specifically, the program execution apparatus 102 is constructed of a microprocessor, a RAM, a ROM, and other units. The ROM stores a computer program. The microcomputer operates according to the computer program, so as to function as the virtual machine unit 170.

41. The following is an explanation of the components that constitute the program conversion apparatus 101 and the program execution apparatus 102.

42. 1.1 The Base Class Library Storage Unit 150

43. The base class library storage unit 150 is constructed of a hard disk unit and includes a base class area, a base method number table, and a base method serial number table.

44. The base class area prestores at least one base class written using machine language instruction strings for a computer system on which the Java virtual machine is operated. The stored base classes can be invoked and used in any program written in Java.

45. The base method number table includes pairs consisting of method names and base method numbers for each base class. Method names are identifiers for identifying methods. The method names included in the pairs identify only methods that can be overridden and methods that can override other methods. Base method numbers are set for base methods in each base class so that each base method within one base class has a different number.

46. The base method serial number table includes at least one pair consisting of a method and a base method serial number for each base class. Method names are identifiers for identifying methods. Methods included in each base class can be identified by the method names included in the pairs. Base method serial numbers are set for base methods so that each base method in the base method serial number table has a different number.

47. As one example, the base class library storage unit 150 includes base classes “string”, “io”, and “program”. A list of base classes and methods stored in the base class library unit 150 are shown in FIG. 2.

48. As one example of the base method number table, the base method number table 250 is shown in FIG. 3. The base method number table 250 includes two pairs consisting of method names and base method numbers for the base class “string” as shown by reference numeral 251. The base method numbers included in these pairs are “0” and “1”, that is, different numbers are used within the class as explained above. As reference numeral 253 shows, the base method number table 250 includes two pairs for the base class “program”. As reference numeral 252 shows, no such pair exists for the base class “io”. No base method number is added to a static method.

49. As one example of the base method serial number table, the base method serial number table 260 is shown in FIG. 4. The base method serial number table 260 includes three pairs consisting of method names and base method serial numbers for the base class “string” as shown by reference numeral 261. As reference numeral 263 shows, six pairs exist for the base class “program”. As shown in the figure, the base method serial numbers included in the pairs in the base method serial number table 260 are “0”, “1”, “2”, . . . “11”, hat is, the base method serial numbers are set so that each base method serial number is different from the others in the base method serial number table 260 as explained above. As can be seen from the figure, base method serial numbers are also added to the static methods.

50. 1.2 The Source File Storage Unit 110

51. The source file storage unit 110 is constructed of a hard disk unit and stores files that include a source program written in Java.

52. As examples of files stored in the source file storage unit 110, files 210 and 220 are respectively shown in FIGS. 5 and 6.

53. The file 210 is a program that includes a definition of a class “prog1” written in Java. The class “prog1” inherits the “program” class. The file 220 is a program that includes a definition of a class “prog2” written in Java. The class “prog2” inherits the “program” class.

54. In the file 210, an instruction 211 declares variable x. Here, variable x is an object of the “program” class.

55. An instruction 212 assigns an object of one class to variable x. As for instructions 213, when an expression “x!=null” is true, instructions 214 and 215 are repeated.

56. The instruction 214 executes a method included in the object indicated by variable x.

57. The instruction 215 assigns an object of one class to variable x.

58. In this way, the instruction 214 executes a method included in the object indicated by variable x. Therefore, a method to be executed by the instruction 214 is not decided until the instruction 212 is executed and a value of variable x is decided.

59. 1.3 The Compiling Unit 120

60. The compiling unit 120 reads a source program that includes a plurality of classes stored in the source file storage unit 110, compiles the read source program to generate one class file for each of the classes, and writes each generated class file into the class file storage unit 130.

61. Here, the compiling of a source program written in Java is not explained as it is well-known.

62. As one example, the compiling unit 120 compiles the source program, files 210 and 220, stored in the source file storage unit 110, generates class files 310 and 320 (shown in FIGS. 7 and 8), and writes the generated class files 310 and 320 into the class file storage unit 130.

63. 1.4 The Class File Storage Unit 130

64. The class file storage unit 130 is constructed of a hard disk unit and includes an area where at least one class file is stored.

65. As examples of class files stored in the class file storage unit 130, class files 310 and 320 are respectively shown in FIGS. 7 and 8.

66. It should be noted here that while class files are expressed using machine code for a Java virtual machine, the class files 310 and 320 are expressed using assembler program code to make the contents of the class files easier to understand.

67. The class file 310 includes a constant pool 311 and a method unit 312. The class file 320 includes a constant pool 321 and a method unit 322.

68. A constant pool includes at least one constant pool entry. In the constant pool 311 or 321, numbers with the symbol “#” are constant pool entry numbers for identifying character strings stored in the constant pool. An expression in brackets “< >” following the symbol “#” and the number, such as “Class prog1” following “#3” is a character string stored in the constant pool entry indicated by the constant pool entry number.

69. It should be noted here that the symbols, such as “#1”, and “< >”, are used only for making the contents of the class files easier to understand. The constant pools do not actually include such symbols.

70. In the method unit 312 or 322, numbers appearing first in lines, such as “0”, “3” or “4”, are line numbers for machine instructions. Expressions following the line numbers, such as “new” and “dup”, are machine instructions for the Java virtual machine. Expressions following the machine instructions, such as “#3”, “#5” and “17”, are operands of the machine instructions. Numbers following the symbol “#” in the operands are the constant pool entry numbers.

71. It should be noted here that the line numbers are used only for making the contents of the method units easier to understand, and do not actually exist in the method units.

72. 1.5 The Static Link Unit 140

73. As shown in FIG. 1, the static link unit 140 is constructed of a read unit 141, a storage unit 142, a method number deciding unit 143, a method table generating unit 144, a method call instruction converting unit 145, a link unit 146, and an output unit 147.

74. (1) The Read Unit 141

75. The read unit 141 receives an indication of one class file from a user, reads the indicated class file from the class file storage unit 130, and writes the read class file into the storage unit 142.

76. Also, the read unit 141 reads all the base classes stored in the base class area in the base class library storage unit 150, reads the base method number table and the base method serial number table stored in the base class library storage unit 150, and writes the read base classes, the base method number table, and the base method serial number table into the storage unit 142.

77. Following this, the read unit 141 judges whether a class that has not been read is used in the class file indicated by the user. If the read unit 141 judges that an unread class is used, it reads a class file that indicates the unread class and writes the read class file into the storage unit 142.

78. (2) The Storage Unit 142

79. The storage unit 142 is constructed of a RAM, and includes an area where a plurality of class files, a plurality of base classes, a base method number table and a base method serial number table are stored.

80. The class files, the base classes, the base method number table, and the base method serial number table are not explained here as they are described earlier in this text.

81. (3) The Method Number Deciding Unit 143

82. The method number deciding unit 143 performs a judgement on each class indicated by a plurality of class files stored in the storage unit 142, as to whether the base method number table includes pairs consisting of method names and method numbers that indicate the class. If the judgement is negative, the method number deciding unit 143 adds a method number to each of the methods including override methods in the class so that each method number within the class is different. Here, when a class from which the present class is derived includes a same method as a method in the derived class, the method number deciding unit 143 numbers the method in the derived class using the same number. The method number deciding unit 143 then writes the generated pairs consisting of method names and method numbers into the base method number table in the storage unit 142. The method number deciding unit 143 also performs a judgement on a superclass of the present class in the same way, as to whether the base method number table in the storage unit 142 includes method numbers of the methods in the superclass. If the judgement is negative, the method number deciding unit 143 generates pairs consisting of method names and method numbers for the methods in the superclass and writes the generated pairs into the base method number table into the storage unit 142.

83. Examples of pairs consisting of method names and method numbers generated by the method number deciding unit 143 are shown in FIG. 9. In the figure, the method number deciding unit 143 is indicated by reference numeral 270 and generates at least one pair consisting of a method name and a method number for each class.

84. As shown by reference numeral 271, two pairs consisting of method names and method numbers are generated for the class “prog1”. Method numbers included in each pair are “0” and “1”, that is, the method numbers are set so that each number within one class is different. As shown by reference numeral 272, two pairs consisting of method names and method numbers are generated for the class “prog2”.

85. These two methods are the same as the methods in the superclass “program”, therefore, the same numbers used in the superclass have been added to these two methods.

86. As described above, the method number deciding unit 143 adds a method number to each method that can be overridden and each method that has been overridden in such a way that each method number within one class is different from the others. Here, a method that has inherited from a method in a superclass, or a method that has overridden a method in a superclass is given the same number as in the superclass. It should also be noted that when a superclass of a class is included in the base class library storage unit 150, methods in the class are given the same numbers as in the base method number table.

87. (4) The Method Table Generating Unit 144

88. The method table generating unit 144 generates a blank method table for each class file stored in the storage unit 142. The method table generating unit 144 then selects pairs consisting of method names and method numbers corresponding to the class file in the base method number table, and performs a judgement on each of the methods indicated by the selected method numbers as to whether the method has been inherited from the base class library.

89. If the method is judged not to be a method that has been inherited from the base class library, the method table generating unit 144 generates a pointer for the method, the pointer being an offset from a first position of an executable program to an area where information relating to the method is stored, and writes the generated pointer into the blank method table. In this way, pointers are generated for methods inherited from the base class library and are written into the method table in generated order. That is to say, the generated pointers are written into the method table in order of the method numbers. Here, it is assumed that an offset does not exceed “0x80000000”.

90. If the method is judged to be an inherited method, the method table generating unit 144 obtains a base method serial number of the corresponding method in the superclass from the base method serial number table. The method table generating unit 144 then generates a pointer for the method using the following equation, and writes the generated pointer into the blank method table. In this way, pointers are generated for methods that have been inherited from the base class library and are written into the method table in generated order.

### Equation

Pointer=0x80000000+(obtained base method serial number)

91. The method table generating unit 144 then additionally writes the generated method table at the first position of the class file.

92. More specifically, a method table 412 shown in FIG. 10 is generated for the class “prog1”. Here, as a method “printclass()” is defined in the class “prog1”, a pointer to a first position of the method is stored in the method table 412. On the other hand, a method “extra()” is not defined in the class “prog1” and has been inherited from the base class library. Thus, the value “0x80000000” is added to a base method serial number “8” of the method “extra()” in the base method serial number table, and the resulting value is stored in the method table 412.

93. (5) The Method Call Instruction Conversion Unit 145

94. The method call instruction conversion unit 145 judges whether a method call instruction “invokevirtual” is present in each class file stored in the storage unit 142.

95. When the method call instruction “invokevirtual” is present in a class file, the method call instruction conversion unit 145 acquires a base method number of a method called by the method call instruction “invokevirtual” from pairs corresponding to the present class file in the base method number table. Following this, a constant pool entry number given in an operand of the method call instruction “invokevirtual” is replaced with the acquired base method number. At this point, a constant pool entry indicated by the constant pool entry number is deleted.

96. In more detail, an argument of the method call instruction “invokevirtual” in the class file 310 is a constant pool entry number “#10” that indicates the method “printclass()”. The constant pool entry number “#10” is replaced with a method number “0” of the method “printclass()”.

97. (6) The Link Unit 146

98. The link unit 146 performs a judgement on each class file stored in the storage unit 142 as to whether an instruction “invokestatic” or an instruction “invokespecial” is present in the class file. When either of these instructions is present in the class file, the link unit 146 obtains a base method serial number of a method called by the instruction from pairs corresponding to the class file in the base method serial number table and replaces the constant pool entry number given in an operand of the instruction with the obtained base method serial number. At this point, a constant pool entry indicated by the constant pool entry number is deleted.

99. Also, the link unit 146 replaces other operands that call methods in the class file with offsets from a first position of an executable program to respective areas where information relating to the methods are stored.

100. (7) The Output Unit 147

101. The output unit 147 reads each class file stored in the storage unit 142 and writes the read class files into the execution program storage unit 160 as executable files.

102. 1.6 The Execution Program Storage Unit 160

103. The execution program storage unit 160 is constructed of a hard disk unit, and includes an area where at least one executable file is stored.

104. The executable file includes a constant pool, a method table, and a method unit.

105. As examples of executable files stored in the execution program storage unit 160, executable files 410 and 420 are respectively shown in FIGS. 10 and 11. It should be noted here that executable files are written using machine code for the Java virtual machine, however, the executables files 410 and 420 are expressed using assembler program code to make the contents of the executable files easier to understand.

106. The executable file 410 shown in FIG. 10 includes a constant pool 411, a method table 412, and a method unit 413.

107. In the constant pool 411, a number with the symbol “#” is a constant pool entry number for identifying a character string stored in the constant pool. An expression “String “Prog1”” following “#1” is a character string stored in a constant pool entry indicated by the constant pool entry number.

108. It should be noted here that symbols in the figure, such as “#1” and “< >”, are not actually included in the executable file.

109. In the method table 412, numbers “0” and “1” appearing first in lines are entry numbers. Expressions following the entry numbers “[Method void printclass ()]” and “0x80000008” are addresses. The expression “[Method void printclass()]” represents an offset from a first position of the executable file 410, pointing to the method “[Method void printclass ()]”. The expression “0x80000008” indicates a method corresponding to the base method serial number “8” (=0x80000008−0x80000000) in the base method serial number table.

110. On line number 18 in the method unit 413, an operand “0” following an instruction “invokevirtual” indicates that an address stored in the entry indicated by the entry number “0” in the method table 412 is to be referred to.

111. On line number 21 in the method unit 413, an operand “0x80000011” following an instruction “invokestatic” indicates that a method corresponding to the base method serial number “11” (=0x80000011−0x80000000) in the base method serial number table is to be referred to.

112. The other operands included in the method unit 413 in the executable file 410 are not explained here as they are the same as in the class file 310 explained above.

113. It should be noted here that descriptions following “//” in the executable file 410 are comments that are not included in the class files 310 and 320.

114. The executable file 420 in FIG. 11 includes a constant pool 421, a method table 422, and a method unit 423. The executable file 420 is not explained here as it has the same data construction as the executable file 410.

115. 1.5 The Base Class Library Storage Unit 190 and the Execution Program Storage Unit 180

116. The base class library storage unit 190 and the execution program storage unit 180 in the program execution apparatus 102 are respectively the same as the base class library storage unit 150 and the execution program storage unit 180 in the program conversion apparatus 101, and so respectively store the same contents.

117. 1.6 The Virtual Machine Unit 170

118. As shown in FIG. 1, the virtual machine unit 170 is constructed of a read unit 171, an instruction execution unit 172, a method table read unit 173 and a method call unit 174.

119. When a plurality of executable programs are indicated by the user, the virtual machine unit 170 executes instructions in the executable programs alternately.

120. (1) The Read Unit 171

121. The read unit 171 receives an indication of at least one executable file from the user, and read the indicated executable file from the execution program storage unit 180.

122. The read unit 171 reads one instruction after another from the read executable file. If the read instruction is an instruction “invokevirtual”, the read unit 171 outputs the instruction to the method table read unit 173, or if not, to the instruction execution unit 172.

123. The read unit 171 repeats the above processing until all the instructions in the executable file are read.

124. (2) The Instruction Execution Unit 172

125. The instruction execution unit 172 receives an instruction from the read unit 171, and executes the received instruction in the same way as in the Java virtual machine.

126. (3) The Method Table Read Unit 173

127. The method table read unit 173 receives an instruction from the read unit 171, reads a content of an entry indicated by an entry number given in an operand of the received instruction from the method table, and outputs the read content to the method call unit 174.

128. (4) The Method Call Unit 174

129. The method call unit 174 receives a content read by the method table read unit 173, and judges whether a value of the received content is “0x80000000” or higher. When the judgement is positive, the value “0x80000000” is subtracted from the value of the content. By setting the resulting value as a base method serial number, a method is identified by the base method serial number in the base method serial number table, and the identified method is called. When the above received content is lower than the value “0x80000000”, the content is an offset from a first position of an executable program. An address is obtained by adding a value of the first address of the executable program that includes the method to a value of the received content, and a method stored at the obtained address is called.

130. 2. The Operation of the Program Conversion/Execution System 100

131. The following is an explanation of the operations of the program conversion apparatus 101 and the program execution apparatus that make up the program conversion/execution system 100.

132. 2.1 The Operation of the Program Conversion Apparatus 101

133. The operation of the static link unit 140 in the program conversion unit 101 is explained with reference to flowcharts shown in FIGS. 12 through 15.

134. The read unit 141 receives an indication of one class file from a user, reads the indicated class file from the class file storage unit 130, and writes the read class file into the storage unit 142 (S101). The read unit 141 reads all the base classes stored in the base class area in the base class library storage unit 150, reads the base method number table and the base method serial number table stored in the base class library storage unit 150, and writes the read base classes, the base method number table, and the base method serial number table into the storage unit 142 (S102). The read unit 141 judges whether the present class file includes a class that has not been read, and if the judgement is positive (S103), the read unit 141 reads a class file that indicates the unread class from the class file storage unit 130 and writes the read class file into the storage unit 142 (S104). The processing then returns to step S103. The above process is repeated until all class files that indicate the classes used in the present class file are read.

135. Following this, the method number deciding unit 143 selects one method included in one of the plurality of class files stored in the storage unit 142 (S111). The method number deciding unit 143 judges whether the base method number table includes a pair consisting of a method name and a method number of the selected method. If the above judgement is negative (S112), the method number deciding unit 143 generates a pair consisting of a method name and a method number for the selected method and writes the generated pair into the base method number table in the storage unit 142 (S113). The processing then advances to step S114. The method number deciding unit 143 performs a judgement on a method corresponding to the selected method in a superclass of the present class as to whether the storage unit 142 stores a base method number table that includes a pair consisting of a method name and a method number of the method in the superclass (S114), and if not, selects the method in the superclass (S116). The processing then goes on to step S113.

136. If the base method number table is judged to include a pair consisting of a method name and a method number of the selected method (S112), the processing advances to step S115.

137. If an unselected method remains, (S115), the processing returns to step S111. When all the methods in the plurality of class files stored in the storage unit 142 have been selected by the method number deciding unit 143 (S115), the method table generating unit 144 selects one class file (S121). The method table generating unit 144 generates a blank method table for the selected class file (S122). Following this, the method table generating unit 144 selects a pair consisting of a method name and a method number which corresponds to the selected class file in the base method number (S123). The method table generating unit 144 judges whether a method indicated by the method name in the selected pair is inherited from the base class library.

138. If the method is judged not to be an inherited method (S124), the method table generating unit 144 generates a pointer that is an offset from a first position of an executable program to an area where information relating to the method is stored (S125), and writes the generated pointer at a position showing the order in which it was generated into the method table generated by the method table generating unit 144 (S126). The processing advances to step S127.

139. If the indicated method is judged to be an inherited method (S124), the method table generating unit 144 obtains a base method serial number of a corresponding method in the superclass of the present class (S130), generates a pointer using the above equation (S131), and writes the generated pointer at a position showing the order in which it was generated into the method table generated by the method table generating unit 144 (S126). The processing then advances to step S127.

140. If an unselected method remains (S127), the processing returns to step S123. When all the methods corresponding to the selected class file have been selected (S127), the method table generating unit 144 additionally writes the generated method table into the class file (S128), and the processing advances to step S129.

141. If unselected class file remains (S129), the processing returns to step S121. When all the class files have been selected by the method table generating unit 144 (S129), the method call instruction converting unit 145 reads one class file (S141). The method call instruction converting unit 145 reads one instruction in the read class file (S142). The method call instruction converting unit 145 judges whether the read instruction is the instruction “invokevirtual”. If so (S143), the method call instruction converting unit 145 obtains a base method number of a method called by the instruction “invokevirtual” (S144), replaces a constant pool entry number given in an operand of the instruction “invokevirtual” with the obtained base method number, and deletes a constant pool entry indicated by the constant pool entry number (S145). The processing advances to step S146.

142. If the read instruction is judged not to be the instruction “invokevirtual” (S143), the processing advances to step S146.

143. If an unread instruction remains (S146), the processing returns to step S142. If all the instructions in the present class file have been read (S146), the method call instruction converting unit 145 replaces the present class file stored in the storage unit 142 with the updated class file (S147), and the processing advances to step S148.

144. If an unread class file remains (S148), the processing returns to step S141. If all the class files have been read by the method call instruction converting unit 145 (S148), the link unit 146 reads one class file (S161).

145. The link unit 146 reads one instruction in the read class file (S162) The link unit 146 judges whether the read instruction is one of the instructions “invokestatic” and “invokespecial”. If the instruction is judged to be one of the instructions “invokestatic” and “invokespecial” (S163), the link unit 146 obtains a base method number of a method called by the instruction (S165), replaces a constant pool entry number given in an operand of the instruction with the obtained base method number, and deletes a constant pool entry indicated by the constant pool entry number (S166). The processing advances to step S167.

146. If the read instruction is judged to be the instruction “invokevirtual” (S163), the processing advances to step S167.

147. If the read instruction is judged to be an instruction other than the instructions “invokestatic” and “invokespecial” (S163), the link unit 146 replaces an operand of the method call instruction in the class file with an offset from a first position of an executable program to an area where information relating to the method is stored (S164). The processing advances to S167.

148. If an unread instruction remains (S167), the processing returns to step S162. If all the instructions have been read (S167), the link unit 146 replaces the present class file with the updated class file (S168), and the processing advances to step S169.

149. If an unread class file remains (S169), the processing returns to step S161. If all the class files by the link unit 146 have been read (S169), the output unit 147 reads each class file stored in the storage unit 142, and writes the read class file into the execution program storage unit 160 as an executable program (S170),

150. 2.2 The Operation of the Program Execution Apparatus 102

151. The following is an explanation of the operation of the program execution apparatus 102 with reference to a flowchart in FIG. 16.

152. The read unit 171 receives an indication of at least one executable file from a user, and reads the indicated executable file from the execution program storage unit 180 (S201).

153. The read unit 171 reads an instruction from the read executable file (S202). The read unit 171 judges whether the read instruction is the instruction “invokevirtual”. If the instruction is judged to be the instruction “invokevirtual” (S203), the read unit 171 outputs the read instruction to the method table read unit 173. On receipt of the instruction, the method table read unit 173 reads the content of an entry indicated by the entry number written in an operand of the received instruction, and outputs the read content to the method call unit 174 (S204). The method call unit 174 receives the content read by the method table read unit 173, and judges whether a value of the content is “0x80000000” or higher. If the judgement is positive (S205), the method call unit 174 subtracts the value “0x80000000” from the value of the content, and calls a method identified by the resulting value from the base method serial number table (S207). The processing advances to step S209. If the read content is lower than the value “0x80000000” (S205), a value of a first address of the executable program that includes the method table is added to the value of the read content, and a method identified by the resulting value is called (S206). The processing then advances to step S209.

154. If the instruction is judged not to be the instruction “invokevirtual” (S203), the read unit 171 outputs the read instruction to the instruction execution unit 172. The instruction execution unit 172 receives the instruction from the read unit 171, and executes the instruction in the same way as in a conventional Java virtual machine (S208). The processing then advances to step S209.

155. The read unit 171 repeats the above processing until all the instructions in the read executable file are read (S209)

### Specific Examples

156. Here, the above described operation is explained in detail with reference to the executable programs shown in FIGS. 10 and 11.

157. In step S201, the executable program 410 shown in FIG. 10 and the executable program 420 shown in FIG. 11 are read. Following this, instructions in a method “main” in each of the executable programs 410 and 420 are alternately executed one after another starting with the first instruction in the executable program 410.

158. First, an instruction “new prog1” in the executable program 410 is executed. As the present instruction is not the instruction “invokevirtual”, the present instruction is executed in the same way as in the conventional virtual machine in step S208. Next, an instruction “new prog2” in the executable program 420 is executed in the same way.

159. The above instructions are executed, generating instances for the class “prog1” and the class “prog2” in a heap area of the virtual machine. Each generated instance includes a pointer to a method table. The execution process for the instructions following the above instructions, except for the instruction “invokevirtual”, are not explained here as it is the same as in the conventional virtual machine.

160. The following is an execution process of the instruction “invokevirtual” in the virtual machine 170 with reference to the execution of the instruction “invokevirtual 0” in the method “main” in the executable program 410.

161. When the instruction “invokevirtual” is executed, either a reference to the instance generated for the instruction “new prog1” or a reference to the instance generated for the instruction “new prog2” is stored at the first position of an operand stack in the virtual machine 170.

162. When the instruction “invokevirtual” is executed, the virtual machine 170 fetches the content indicated by an operand of the instruction “invokevirtual”. When the instance generated for the instruction “new prog1” is stored in the operand stack, a pointer to the method “printclass()” defined in the class “prog1” is fetched. As the pointer is lower than the value “0x80000000”, the virtual machine 170 calls a method indicated by the pointer fetched from the method table. The method “printclass()” in the class “prog1” is called.

163. On the other hand, when the instance generated for the instruction “new prog2” is stored at the first position of the operand stack, a pointer to the method “printclass()” defined in the class “prog2” is fetched. As the fetched pointer is lower than the value “0x80000000”, the virtual machine 170 calls a method indicated by the pointer fetched from the method table. The method “printclass()” in the class “prog2” is called.

164. As described above, the method in the class “prog2” is called by the instruction “invokevirtual” in the class “prog1”.

165. It should be noted here that a reference to one of the instances stored at the first position of the operand stack in the present embodiment equates to the reference variable x shown in FIG. 5.

166. When the instruction “x.printclass()” in FIG. 5 is executed in the present embodiment, and if variable x indicates to look at the instance for the class “prog2”, the method “printclass()” in the executable program 420 is fetched from the executable program 410.

167. 3. Conclusions

168. As described above, the program conversion/execution system in the above embodiment demonstrates the following effects even when a source program written in Java is coded in such a manner that an object of a class is declared by a variable and a method in an object bound with the variable is called. The size of a class file can be reduced by not including identifier information in a constant pool in the class file, moreover, static liking of a plurality of class files can be performed.

169. Although the present invention has been described based on the above embodiment, the invention should not be limited to such. For instance, the following modifications are possible.

170. (1) In the present embodiment, the static link unit 140 reads one class file and outputs one executable program, however, the static link unit 140 may read a plurality of class files, link them, and output the linked class files as one executable program.

171. (2) In the present embodiment, base method serial numbers that are set in advance are used for indicating pointers to methods included in the base class library. However, when pointers to methods included in the base class library in the virtual machine are decided at the time the static linking is performed, the pointers can also be stored in the method table. In that case, methods included in the base class library should be stored at the same addresses in all virtual machines. However, the judgement whether to call a method in the base class library or to call a method indicated by a pointer in the method table becomes unnecessary when an instruction such as the instruction “invokevirtual” is executed, which greatly improves the processing speed.

172. (3) In the above embodiment, base method numbers and base method serial numbers are set in advance for methods included in the base class library, and the base method number table and the base method serial number table are provided in advance. However, the base method numbers and the base method serial numbers may be set when linking is performed by a static linker.

173. (4) The base class library may include a shared reference class that enables a class instance to be referred to by a plurality of programs. Here, the shared reference class includes (a) a reference storing method that refers to a class instance generated when an executable program is executed by a virtual machine, and stores a name of the class instance and (b) a reference fetching method whereby other executable programs refer to a class instance stored by the reference storing method and fetch a name of the class instance.

174. (5) As one example, the program execution apparatus can be a digital broadcast receiving apparatus that may be composed of a microprocessor, a RAM, a ROM, a tuner unit, a demodulation unit, a transport decoder, an audio signal generation unit, and a video signal generation unit. The digital broadcast receiving apparatus receives digital broadcast waves and outputs audio and video data. The virtual machine 170 may control the tuner unit, the demodulation unit, the transport decoder, the audio signal generation unit, and the video signal generation unit.

175. Alternatively, the program execution apparatus 102 may be a DVD (Digital Video Disk) player, a portable information terminal, a portable telephone, or other household electric appliance.

176. (6) The present invention may relate to the method described above, a computer program that makes a computer realize the above method, and digital signals that represent the computer program.

177. The present invention may further relate to a computer-readable storage medium, such as a floppy disk, a hard disk, a CD-ROM, an MO (Magneto-Optical Disc), a DVD, a DVD-ROM, a DVD-RAM, or a semiconductor memory that stores the above computer program or the digital signals, and may also relate to the computer program or the digital signals stored in the above computer-readable storage medium.

178. The computer program or digital signals for realizing the present invention may be transmitted via an electric communication line, a wireless/cable transmission circuit or a network such as the Internet.

179. The above embodiment of the present invention may be a computer system comprising a microprocessor and a memory. Here, the memory may store the computer program, and the microprocessor may operate according to the computer program.

180. By storing the computer program or the digital signals in any of the storage media listed above and transferring the storage media to an independent computer system, or by transmitting the computer program or the digital signals to an independent computer system via a network, a computer program of for the present invention may be executed in the independent computer system.

181. (7) The above embodiment of the present invention and the modifications may also be combined.

182. Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A link apparatus that links a plurality of class files generated when a source program written in an object-oriented language is compiled, each class file including a constant pool, and that outputs each class file as an executable program,
the link apparatus comprising:
class file storing means for storing at least one class file that includes a method and an identification character string to identify the method, the identification character string being stored in the constant pool in the class file;
address adding means for (1) reading each class file from the class file storage means, (2) detecting, in different class files that are read, a plurality of methods that are identified by a same identification character string, and (3) writing an address of each detected method into a fixed position in each class file, the address showing a storage position of the method in the class file; and
character string deleting means for deleting an identification character string that identifies the detected method from a constant pool in each class file into which an address is written, and
wherein the link apparatus outputs, after the address adding means writes an address into a class file and the character string deleting means deletes an identification character string from the class file, the class file as an executable file.

2. The link apparatus of claim 1,
wherein the address adding means comprises:
method number generating means for generating a same method number for the plurality of methods included in the different class files and identified by the same identification character string; and
address generating means for generating an address showing a position where code of a method for which a method number is generated is stored in a class file, and writing the generated address in correspondence to the method number into the fixed position in the class file, and
wherein the character string deleting means deletes the identification character string that identifies the method for which the method number is generated.

3. The link apparatus of claim 2,
wherein the address generating means generates a method table for each class file, the method table associating the generated address with the method number, and writes the generated method table into the fixed position in the class file.

4. The link apparatus of claim 3,
wherein class files stored by the class file storing means each include an entry area in a constant pool, the entry area being identified by an entry number and storing the identification character string, and
one of the class files stored by the class file storing means further includes at least one method,
the method including:
(a) an instruction to bind a variable with an instance of one class; and
(b) a call instruction that includes an entry number and calls code of a method identified by an identification character string stored in an entry area indicated by the entry number and included in the instance bound with the variable, and
wherein the link apparatus further comprises,
instruction converting means for replacing, when a method in a class file includes the call instruction, the entry number in the call instruction in the class file with a method number generated for a method identified using the entry number.

5. The link apparatus of claim 4 further comprising:
base class storing means for storing at least one base class file that can be shared by other programs, the base class file including base methods; and
base method number deciding means for generating a base method number for each base method that can be overridden or that can override another base method so that each base method number is different, and
wherein the method number generating means generates (1) a method number for a method that inherits a base method or that overrides a base method so that the method number is the same as a base method number of the base method generated by the base method number deciding means, or (2) a method number for another method so that the method number is unique in a class.

6. The link apparatus of claim 5, further comprising:
base method serial number deciding means for generating a base method serial number for each base method in each base class stored by the base class storing means so that each base method serial number is different, and
wherein the address generating means generates a method table for a method that can be called by an instance of a class file, the method table including (1) a base method serial number generated by the base method serial number deciding means when a method to be called is a base method in a base class stored by the base class storing means, or (2) a pointer to an address indicating a storage position of code of a method when a method to be called is not a base method in a base class stored by the base class storing means.

7. The link apparatus of claim 6,
wherein the base class storing means includes a shared reference class that enables a class instance to be referred to by a plurality of programs,
the shared reference class including:
(a) a reference storing method that refers to a class instance generated when an executable program is executed by a virtual machine, and stores a name of the class instance; and
(b) a reference fetching method whereby other executable programs refer to a class instance stored by the reference storing method and fetch a name of the class instance.

8. A virtual machine that operates according to an executable program outputted by the link apparatus of claim 4,
the virtual machine comprising:
instruction reading means for reading a call instruction included in the executable program;
method number reading means for reading an address corresponding to a method number included in the read call instruction from a method table; and
execution means for branching to the read address and executing code of a method stored at a position indicated by the read address.

9. A virtual machine that operates according to an executable program outputted by the link apparatus of claim 5, the virtual machine comprising:
instruction reading means for reading a call instruction included in the executable program;
method number reading means for reading an address corresponding to a method number included in the read call instruction from a method table; and
execution means for branching to the read address and executing code of a method stored at a position indicated by the read address.

10. A virtual machine that operates according to an executable program outputted by the link apparatus of claim 6, the virtual machine comprising:
instruction reading means for reading a call instruction included in the executable program;
method number reading means for reading a content stored in correspondence to a method number included in the read call instruction from a method table; and
execution means for branching to the read address and executing code of a method stored at a position indicated by the read address when the read content is an address of a method, or branching to a base method indicated by the base method serial number and executing the base method when the read content is a base method serial number.

11. An information processing system comprising:
a compiling apparatus that compiles a source program written in an object-oriented language and generates a plurality of class files that each include a constant pool;
the link apparatus of claim 4 that links the class files and outputs each class file as an executable program; and
the virtual machine of claim 8 that operates according to the outputted executable program.

12. A link apparatus that links a plurality of class files generated when a source program written in an object-oriented language is compiled, each class file including a constant pool, and that outputs each class file as an executable program, the link apparatus comprising
class file storing means for storing at least one class file that includes a method and an identification character string to identify the method, the identification character string being stored in the constant pool in the class file, and
the link method including:
address adding step for (1) reading each class file from the class file storage means, (2) detecting, in different class files that are read, a plurality of methods that are identified by a same identification character string, and (2) writing an address of each detected method into a fixed position in each class file, the address showing a storage position of the method in the class file; and
character string deleting step for deleting an identification character string that identifies the detected method from a constant pool in each class file into which an address is written, and
wherein the link method outputs, after the address adding means writes an address into a class file and the character string deleting means deletes an identification character string from the class file, the class file as an executable file.

13. A computer-readable storage medium for storing a link program used in a link apparatus that links a plurality of class files generated when a source program written in an object-oriented language is compiled, each class file including a constant pool, and that outputs each class file as an executable program, the link apparatus comprising:
class file storing means for storing at least one class file that includes a method and an identification character string to identify the method, the identification character string being stored in the constant pool in the class file, and
the link program comprising:
address adding step for (1) reading each class file from the class file storage means, (2) detecting, in different class files that are read, a plurality of methods that are identified by a same identification character string, and (3) writing an address of each detected method into a fixed position in each class file, the address showing a storage position of the method in the class file; and
character string deleting step for deleting an identification character string that identifies the detected method from a constant pool in each class file into which an address is written, and
wherein the link program outputs, after the address adding means writtes an address into a class file and the character string deleting means deletes an identification character string from the class file, the class file as an executable file.

14. A computer-readable storage medium that stores executable files outputted by the link apparatus of claim 1.
